(19) United States
(12) Patent Application Publication
(10) Pub. No.: US 2007/0000818 A1
(43) Pub. Date: Jan. 4, 2007

(54) Method and device for processing graphical information found on postal deliveries

(75) Inventors: Alexander Delitz, Bonn (DE); Elke Robel, Bonn (DE); Dieter Stumm, Grossefehn (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 10/568,141

(22) PCT Filed: Jun. 30, 2004
(86) PCT No.: PCT/DE04/01377

§ 371 Date: Feb. 9, 2006

(30) Foreign Application Priority Data
Aug. 11, 2003 (DE) 103 37 164.8

(51) Int. Cl. B07C 5/00

(52) U.S. Cl. 209/534

(57) ABSTRACT

A method and a device for processing graphical information found on postal deliveries, wherein the graphical information of a first postal delivery is sorted on the basis of a first result of an evaluation, physical sorting of a second postal delivery is triggered by the sorting of the graphical information on the first postal delivery, and a further physical sorting of the first postal delivery, resulting from a reference code, is carried out.

### BACKGROUND

1. Field of the Invention

The invention relates to a method for processing graphic information present on mailpieces, whereby the graphic information is acquired, stored and evaluated.

The invention also relates to a device that is suitable for carrying out the method.

2. Description of Related Art

German Preliminary Published Application DE 101 50 457 A1 describes a method as well as a device for processing graphic information present on the surfaces of mailpieces. For this purpose, the graphic information present on the mailpieces is acquired and evaluated locally by an image processing station, whereby it is checked whether the acquired graphic information differs from the expected graphic information. In case the acquired graphic information differs from the expected graphic information, the acquired graphic information is transmitted to a central image processing unit. The mailpieces are physically sorted as a function of the checking procedure.

Another method of the generic type as well as a device of the generic type is described in German Preliminary Published Application DE 101 50 464 A1, whereby the method as well as the device are used especially for checking postage. In order to check the postage, the postage indicia present on the mailpieces are acquired and checked.

German Preliminary Published Application DE 101 31 254 A1 discloses a method for verifying the authenticity of a postage indicium applied onto a mailpiece, whereby cryptographic information contained in the postage indicium is decrypted and used for verifying the authenticity of the postage indicium. Furthermore, this German preliminary published application describes the use of a database for storing mail-specific data. Here, especially customer system identification information is compiled in the database.

German Patent DE 100 10 241 C1 describes a method and a device for reading addresses on mailpieces. The invention relates to the reading of the addresses on mailpieces, in which process images of the mailpiece surface that have been evaluated by at least one OCR unit are transmitted to several video encoding stations for manual encoding by video encoding personnel if the reading result (also called rejection) was not unambiguous.

German Preliminary Published Application DE 101 50 455 A1 discloses a method and a device for processing mailpieces that checks whether the mailpiece has postage. If it has no postage, or if the postage differs from the expected postage, then a payment assurance code is printed onto the mailpiece. The subsequent sorting procedure is carried out as a function of the payment assurance code.

German Patent DE 199 47 259 C1 describes a method for sorting mailpieces in several sorting runs. In order not to have to read the addresses and not to have to print machine-readable identification codes on each mailpiece during each sorting run, characteristic features of the mailpieces are additionally ascertained during the first sorting run and stored together with the distribution codes acquired in the reading process. During the subsequent sorting runs, only the characteristic features of the mailpieces are acquired and these are compared to the stored features. If they match, then the applicable distribution code is assigned to the mailpiece.

The above-mentioned methods as well as devices share the objective of checking the mailpieces for correct postage and of only conveying correctly franked mailpieces. A drawback of all of the above-mentioned inventions is the fact that the physical sorting is subject to a finite number of pre-specified sorting features, whereby each acquired case of postage fraud is classified under one of the possible sorting features.

If a new fraud pattern cannot be classified under one of the sorting features, then the mailpiece in question is removed from the conveying sequence without it being possible for the sorting features to be adapted to this new fraud pattern, which is a major drawback of the known methods. Another drawback of the known methods lies especially in the fact that each mailpiece—also in the event of a repeated case of fraud—passes through a complete postage checking cycle, which comes at the expense of the conveying speed of all of the mailpieces.

Moreover, international patent application WO 02/0822235 describes a system for processing goods that are sent back to a merchant by customers. Here, first of all, an image of the surface of the packages containing the goods as well as their weight are acquired and stored in a database. On the basis of this data, the postage to be paid is calculated and compared to the postage that has been applied to the packages in order to draw up reports indicating the amount of postage that still has to be paid by the merchant. In order to draw up suitable groupings of images for the processing, a sorting of the images can be carried out.

### SUMMARY OF THE INVENTION

The invention is based on the objective of refining a method of the generic type in such a way that mailpieces of a sorting process are processed in a mail distribution center or in several mail distribution centers, whereby the sorting processes are optimized on the basis of a processing result without this causing any delay. In this manner, cases of fraud, for example, due to forged postage indicia, are eliminated and all kinds of fraud patterns are recognized.

This objective is achieved according to the invention with a method of the generic type in that, on the basis of a first result of the evaluation of the graphic information, a database is augmented by additional sorting features, whereby the surface video data contained in the graphic information and/or the statistical evaluation are imaged, and whereby moreover, using the augmented database, a second result of the evaluation is ascertained so that, on the basis of the results of the evaluation, the graphic information of a first mailpiece is sorted, whereby this sorting of the graphic information of the first mailpiece triggers a physical sorting of a second mailpiece, and furthermore, in that another physical sorting of the first mailpiece resulting from a reference code is carried out.

In particular, the method is suitable for the evaluation of graphic information in mail or freight centers.

Preferably, the method according to the invention allows a determination of postage indicia present on the mailpieces.

The evaluation according to the invention of the graphic information of the mailpiece will be referred to in short below as “virtual fine sorting” (virtual FS). The term virtual is used in order to express the fact that the appertaining sorting is not carried out physically even though the virtual FS determines a physical sorting. Fundamentally, the virtual FS with its suitable means allows a sorting of mailpieces in a graphic and/or numeric configuration so that especially graphic information of mailpieces is sorted. Since the virtual FS comprises another checking of the postage—referred to below as virtual checking of the postage—unintentional cost-free conveying is ruled out according to the invention.

As a matter of principle, the virtual FS can be integrated at any desired point of the conveying sequence for mailpieces inside or outside of mail or freight centers.

The term “virtual” according to the invention also relates to a method for the computer-aided evaluation of the graphic information, whereby preferably standardized computer-aided evaluation methods are used. Moreover, according to the invention, it has proven to be particularly advantageous to use an evaluation method that is specially optimized for the conveying sequence in a mail or freight center.

The term “computer” is by no means to be construed in a restrictive fashion. This refers to any kind of unit that is capable of performing computations such as, for example, a work station, a personal computer or a microcomputer.

Graphic information is information of any kind that is present on the surface of the mailpiece and that is conducive for graphic imaging or acquisition. It has been found that the term graphic information refers primarily to the postage indicium as well as to the sender field on the mailpiece. Moreover, video data of the entire surface of the mailpieces constitutes part of the graphic information, so that detailed information about a mailpiece can also be acquired. Furthermore, the reference code, which contains information about the result of an already performed evaluation, is also an integral part of the graphic information. After the acquisition has been carried out, the graphic information is stored so that the virtual FS can make use of the stored data.

Results of an automated checking of the postage, namely, concrete information indicating the sorting compartment into which the mailpiece is placed, are printed onto the mailpiece in the form of a one-dimensional or two-dimensional barcode, also called a payment assurance code. This one-dimensional or two-dimensional barcode present on the mailpiece is an example of a reference code.

The automated checking of the postage is configured according to the invention in such a way that correctly franked mailpieces with a complete reference code go into a normal conveying sequence without being entered into a database ZinS.

Mailpiece-relevant data for the optimized support of processing sequences is stored in the database ZinS.

The means for doing this is an expanded utilization of automation in the mail centers so as to obtain detailed information about automatically processed mailpieces. A result is the additional out-sorting of mailpieces into “payment assurance compartments.”

Fundamentally, the database ZinS contains information about automated and virtual checking of the postage as well as information about the sorting procedures that are associated with the checking of the postage. Moreover, results of an evaluation of graphic information are stored in the database ZinS. In particular, the database ZinS has a negative file that contains information about impermissible postage indicia. Furthermore, the database ZinS has a positive file that contains information about correct postage indicia.

If no complete reference code is present on the mailpiece, then a reference code is imprinted on the basis of the automated checking of the postage and said reference code determines the associated physical sorting of the mailpieces. The physical sorting, as the result of the automated checking of the postage, is done, for example, according to the sorting features “insufficient postage” and “suspicion of fraud.”

Moreover, the customer-specific cumulative postage amount registered within a specifiable period of time as well as the customer-specific cumulative postage amount of all paid value cards/value specifications are registered in the database ZinS. Moreover, the database contains entries of comparisons between the determined customer-specific cumulative postage amounts as well as the customer-specific cumulative amounts of all paid value cards/value specifications and the amounts of an automatic franking procedure read within a reporting time period on the basis of acquired sender franking machine (SFM) identifications.

According to the invention, the evaluation of the graphic information is not subject to previously determined sorting features, but rather, additional sorting features for future cases of postage fraud arise from a virtual FS. In particular, the results of the virtual FS are used to augment the database ZinS, or rather to augment the negative file. Consequently, the method according to the invention as well as the device take into account the fact that forgers of postage indicia make use of increasingly refined methods.

After the graphic information, especially the surface video data of the mailpieces, has been acquired, it is stored and is available for evaluation. Preferably, the graphic information is made visible. The storage of the graphic information has the major advantage that future customer-specific documentation about conveyed mailpieces can be generated in a targeted and timely fashion. The type of evaluation can be adapted according to the invention to the requirements within the mail or freight center.

Moreover, storing the graphic information has the major advantage that the evaluation of the stored information is possible even during operational shutdown phases of the conveying system. In this manner, the evaluation of the graphic information is segregated from the conveying of the mailpieces, so that advantageously, the evaluation speed of the mailpieces is retained, even during shutdown phases, which considerably contributes to allowing the mailpiece to be conveyed in a timely fashion.

In an especially preferred embodiment of the invention, in addition to the graphic information, data pertaining to the automated checking of the postage is likewise stored.

If, for example, an impermissible postage indicium is recognized on the basis of the first result of the evaluation of the graphic information of the first mailpiece, then the negative file of the database ZinS is augmented as a function of the sorting of the graphic information. Another automated and/or virtual checking of the postage makes use of the augmented negative file. In cases of fraud, volume analyses of customer segments, of individual customers or of faulty structures can easily be carried out, without intervening in the physical sorting of the first mailpiece that is based on the reference code.

Fundamentally, any reference code can be used. The use of 2-digit reference code has proven to be especially advantageous. Such reference code is used for further evaluation steps. Moreover, the application of a reference code makes it possible to ensure that a mailpiece only undergoes checking of the postage one time and/or is only conveyed into an acquisition system one single time. In order to prevent double acquisitions, a physical rough sorting is carried out at the beginning of the evaluation of the graphic information.

In the eventuality of a second instance of fraud with a previously acquired fraud pattern, the impermissibly franked mailpieces are physically out-sorted on the basis of the previously acquired evaluation results, without having to be bound to pre-specified sorting features. This further advantage of the method according to the invention leads to the registration and recognition of any kind of fraud pattern, which results in an extremely high physical out-sorting rate.

It has proven to be especially valuable to arrange for the evaluation of the graphic information to take place via a data line at a different point in time and/or at a different place than the point in time and/or the place of the physical sorting resulting from the reference code.

A data line as defined in the especially preferred embodiment of the invention is any medium that serves for the loss-free transmission of data. For example, RS 232 cables or coaxial cables can be used as data lines so that, in these cases, data transmission at speeds of up to 100 Mbps (mega bits per second) are achieved.

In another preferred embodiment, the evaluation of the graphic information of the mailpieces comprises statistical evaluations of the graphic information present on the mailpieces.

Advantageously, the statistical evaluation of the graphic information present on the mailpieces provides an additional decision-making criterion for checking the postage since, in this case, the checking of the postage is not limited to an actual classification according to pre-specified sorting features. For this purpose, the surface video data and/or the statistical evaluation is imaged on the basis of the graphic information and this serves for determining a second result of the evaluation, whereby the second result of the evaluation serves to augment the database ZinS.

On the basis of the graphic information, the types of postage of the mailpieces are determined and this serves for ascertaining another result of the evaluation, whereby the results of the determination of the type of postage are output in the form of a code.

Fundamentally, any configuration of the postage indicium can be acquired but it has proven to be especially advantageous to acquire and evaluate postage indicia generated by a sender franking machine (SFM) or else computer-based digital postage indicia.

It is especially advantageous to acquire all postage imprints of a postage indicium generated by an SFM, whereby the postage indicium contains especially the SFM identification as well as the date when the postage indicium was generated.

The authenticity of sender franking is verified in that the graphic information present on the mailpieces is compared to the information expected for this mailpiece, whereby the expected information corresponds to a determination that preceded the comparison, and moreover, the postage indicium is registered as being forged if the information at hand differs from the expected information.

Preferably, determinations ensue from an evaluation of mailpieces preceding the comparison, whereby the evaluation entails a changing number of sorting features.

Fundamentally, the virtual checking of the postage comprises at least the same number of sorting features as the automated checking of the postage.

Preferably, the virtual checking of the postage comprises a number of additional sorting features. For example, another sorting feature is the SFM identification (“identification”) determined through the evaluation. Moreover, on the basis of another sorting feature, it is checked whether an SFM identification is readable (“SFM identification not readable”). Furthermore, on the basis of a sorting feature, it is checked whether a determined SFM identification is present in a negative file (“SFM in negative file”). Likewise, on the basis of a sorting feature, it is checked whether a determined SFM identification is present in a positive file (“SFM not in positive file”). In addition, on the basis of a sorting feature, it is checked whether this is a case of SFM insufficient postage (“SFM insufficient postage”). On the basis of additional sorting features, it is checked whether an SFM currency is readable (“SFM currency not readable”), and moreover, whether an SFM postage indicium is readable (“SFM postage indicium not readable”).

The digital postage indicia contain cryptographic information, for example, about the identity of the customer system that controls the generation of the postage indicium. The decryption of the cryptographic information contained in the postage indicium is part of the evaluation of the graphic information. By integrating the decryption of the cryptographic information into the evaluation process, it is possible to directly verify the authenticity of the digital postage indicia.

Moreover, it is advantageous for another partial evaluation to include a comparison between the date when the digital postage indicium was generated and the current date. The integration of the date when the digital postage indicium was generated—especially in encrypted form—increases the data security, since the comparison between the date when the digital postage indicium was generated and the current date prevents a multiple use of a given digital postage indicium for conveying mailpieces.

Due to the preferred generation technique of such digital postage indicia in personal computers (PC), this type of franking is also referred to as PC franking (PCF). However, these elaborations also apply to other digital postage indicia that can be generated, for example, by means of suitable large-volume printers or by means of franking machines configured for printing digital postage indicia.

The authenticity of a digital postage indicium is verified in that the encoded digital information contained in the graphic information is deciphered and compared to the unencrypted graphic information present on the appertaining mailpiece to see if it matches and, if it does not match, the postage indicium is registered as being forged.

Moreover, a preferred embodiment of the invention allows another checking of the postage, whereby a hash value is generated from data contained in the graphic information in order to check whether this hash value matches a hash value contained in the encoded information and, if it does not match, the postage indicium is registered as being forged. For this purpose, the hash value is formed taking into account information about mailpiece data, taking into account a temporarily stored random number and taking into account a loading procedure identification number.

This gives rise to additional sorting features of the virtual checking of the postage. In particular, on the basis of another sorting feature, it is checked whether the hash value of the PCF is OK (“PCF hash value not OK”). Moreover, on the basis of additional sorting features, a date of a PCF (“PCF date”) is checked, a PCF version (“PCF version”) is checked, PCF insufficient postage (“PCF insufficient postage”) is checked and/or the presence of a determined PCF in a negative file (“PCF in negative file”) is checked.

In addition to the above-mentioned sorting features of the checking of the postage, the graphic information of the mailpiece is evaluated according to other sorting features, leading to a further structuring of the evaluation.

For example, a sorting feature of the evaluation is a time of day of a sorting event, which allows a retrospective analysis of a mailpiece that has already been conveyed.

Another sorting feature of the evaluation is the date of a sorting event. In this manner, registered cases of fraud can advantageously be classified under the registration date, which allows retroactive relationships to be established so as to recognize trends of fraud events over a prolonged period of time.

Moreover, additional sorting features of the evaluation are a starting time and/or an ending time of a sorting event. By indicating a preferred time interval in the form of starting and ending times of a sorting event, a precise time breakdown of the virtual FS is obtained, which also allows additional conclusions to be drawn about coincidences during the conveying processes of mailpieces.

Another sorting feature of the evaluation is a specification of production machines in a mail or freight distribution center based on a machine number, so that a global inclusion of all of the systems involved in the conveying processes is carried out and documented.

Additional sorting features are the value of the insufficient postage determined by means of the evaluation as well as the SFM identification determined by means of the evaluation.

In another preferred embodiment of the invention, at least one means for evaluating the graphic information of the mailpieces is located inside and/or outside of a mail distribution center.

Through a spatial separation of the evaluation and the conveying, it is left up to a user of the method to check the postage either in the immediate vicinity of the conveying or else at a distance away from it. For example, the evaluation of the graphic information can be evaluated by users at any desired location, as long as the means for performing the evaluation is an integral part of the data network.

In this manner, special user groups can be created that are physically concentrated away from the place where the mailpieces are conveyed, resulting in a substantial increase in the evaluation efficiency.

Furthermore, the above-mentioned objective is achieved in conjunction with a device, referred to below as a “virtual fine sorting machine” (virtual FSM), corresponding to the generic part of claim 28, in that the data network is connected to at least one means for performing a physical sorting of mailpieces, at least one means for generating a reference code, and at least one means for evaluating the graphic information, so that the means for evaluating the graphic information of a first mailpiece ascertains a first result of the evaluation, whereby the data network is also connected to a database that has been augmented by an additional sorting feature, for determining a second result of the evaluation and additionally, at least one means for performing the physical sorting of a second mailpiece is activated, whereby another physical sorting of the first mailpiece is carried out on the basis of the reference code.

Within the scope of the virtual FSM according to the invention, a data network includes a complex system of data-processing means and of the data lines that connect the data-processing means, whereby a network can be distinguished from another network by its configuration.

The data network allows the linking of a plurality of data-processing means. Preferably, central storage devices, printers and data scanners are connected to each other and can be used. An especially advantageous aspect of the device according to the invention has proven to be the use of different types of network cards for the data transport. For example, local networks (LANs), wide-area networks on the basis of telephone lines (WANs), homogeneous data networks (networks with the same type of computers and software) and heterogeneous data networks (networks with different types of computers and software) can be used according to the invention. By the same token, it is possible to combine individual types of networks or all of the above-mentioned types of networks with each other. Furthermore, in an especially preferred embodiment of the virtual FSM, a data transport via a data server is made possible.

The means for performing the physical sorting of mailpieces is characterized according to the invention in that the number of sorting compartments corresponds to at least the number of the sorting features resulting from the reference code. Advantageously, the means for performing the physical sorting provides additional sorting compartments, whereby the number of additional sorting compartments is determined by the results of the virtual FS.

According to the invention, the means for generating the reference code is configured in such a way that the graphic information of each mailpiece that is present in a mail distribution center and that is ready to be conveyed further is acquired by at least one analog and/or digital reading means. Therefore, the acquisition according to the invention of the graphic information leads to an analog and/or digital representation of the surfaces of the mailpieces. The acquired representations of the surfaces are stored by at least one means for storing analog or digital signals, whereby the storage is fundamentally independent of the location of the acquisition.

The reading means includes a combination of a code reading unit for reading in the postage indicium and a video data recording unit for generating a video recording of the entire surface of the mailpiece. Moreover, if so desired, the reading means may include two physically separated units, one unit serving to read the postage indicium and the other unit serving to create a video recording of the data on the surface of the mailpiece.

It has proven to be advantageous to use special reading devices to allocate the graphic information to standardized franking systems.

For example, the specialized reading device deciphers the encoded data contained in the graphic information and compares this decoded data to other information from a database.

According to the invention, the means for evaluating the graphic information can be combined with the means for generating the reference code.

Preferably, the means for evaluating the graphic information is connected to the data network in such a way as to be spatially and functionally separated from the means for generating the reference code.

Another embodiment of the virtual FSM is characterized in that at least one means for evaluating the graphic information of the mailpieces has at least one input device as well as at least one display device so that evaluation results as well as surface video data of the mailpieces are displayed to a user and edited by the user employing the input device.

Another characteristic of the virtual FSM, depending on the structural design, is to use different display devices for depicting the evaluation results and the video data. For example, conventional analog and/or digital video equipment can be used as display devices. Moreover, PC-based display devices can be used that allow a filtering of the video data and thus a detailed depiction of specific segments of the video data.

The input device is an interface for representing and transmitting information. For example, PC keyboards, numerical keypads, barcode scanners, speech recognition means, etc. are used to generate the input.

Additional advantages, special features and practical refinements of the invention can be gleaned from the subordinate claims and from the presentation below of preferred embodiments making reference to the drawings.

### BRIEF DESCRIPTION OF THE DRAWINGS

The drawings show the following:

FIG. 1 shows a schematic flow chart of the method according to the invention.

FIG. 2 shows of an example of a display according to the invention of evaluation results, broken down according to sorting features.

FIG. 3 shows of an example of the number of virtual compartments after the evaluation has been completed, taking into account SFM and PCF data records.

FIG. 4 shows another example of a display according to the invention of evaluation results as well as of details of the graphic information.

### DETAILED DESCRIPTION

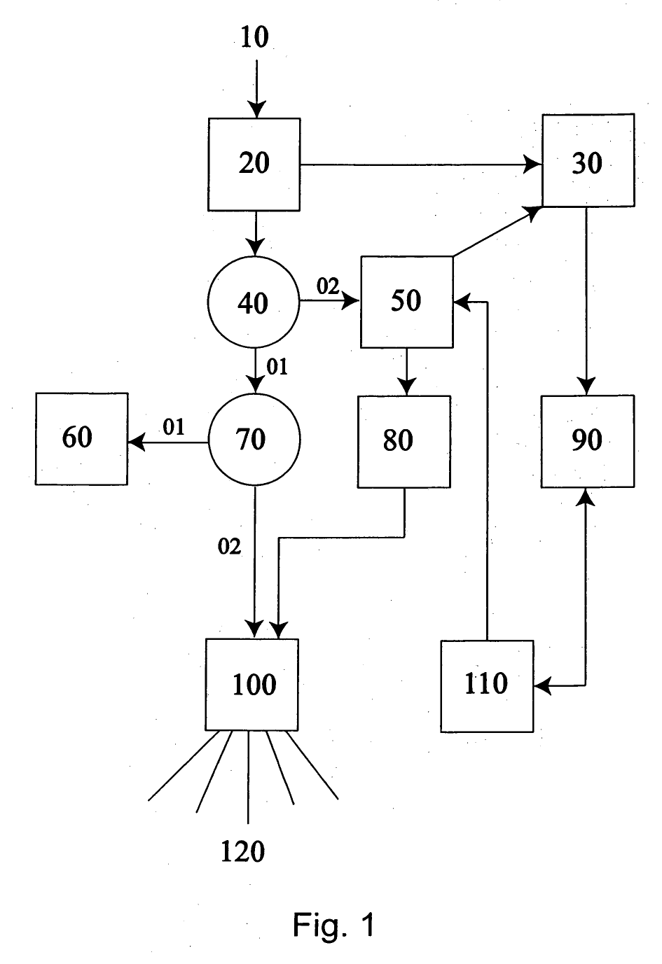

FIG. 1 shows a depiction of a preferred embodiment of the invention in the form of a flow chart for processing graphic information present on mailpieces.

The graphic information 20 present on mailpieces and schematically configured in the form of input information 10 is acquired and fed to a storage device 30. The storage device here is configured so as not to be volatile, so that the graphic information is stored permanently. Moreover, on the basis of the acquired graphic information, it is checked whether the reference code 40 is already present. If the result of the checking for the presence of the reference code is positive 01, it is also checked whether the correct franking is present. If the result of the checking for correct franking is also positive 01, then the appertaining mailpiece is transferred to a normal conveying sequence 60.

If the result of the checking for the presence of the reference code 40 is negative 02, then an automated checking 50 of the postage is carried out. The result of the automated checking of the postage specifies a reference code, whereby the additional reference code 80 is printed onto the mailpiece. As a function of the reference code, the mailpieces are physically sorted 100, whereby the sorting takes place according to the sorting features 120.

If the result of the checking for correct franking 70 is also negative 02, and if a reference code is already present, then the mailpieces are once again physically sorted according to sorting features 120 as a function of the reference code.

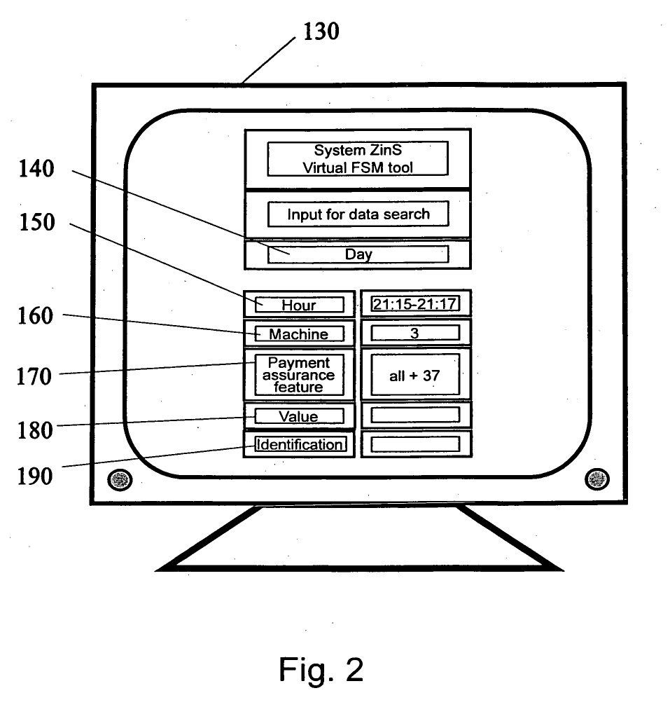

FIG. 2 shows an especially preferred embodiment of the device according to the invention on the basis of the display of evaluation results broken down according to sorting features.

On the basis of a structured presentation form, typical evaluation results, broken down according to sorting features, are displayed by means of the display device 130. Here, the results are listed according to the day 140, the starting and ending time 150, the machine number 160, the utilized payment assurance sorting features 170, the ascertained insufficient postage value 180 as well as according to the ascertained SFM identification 190.

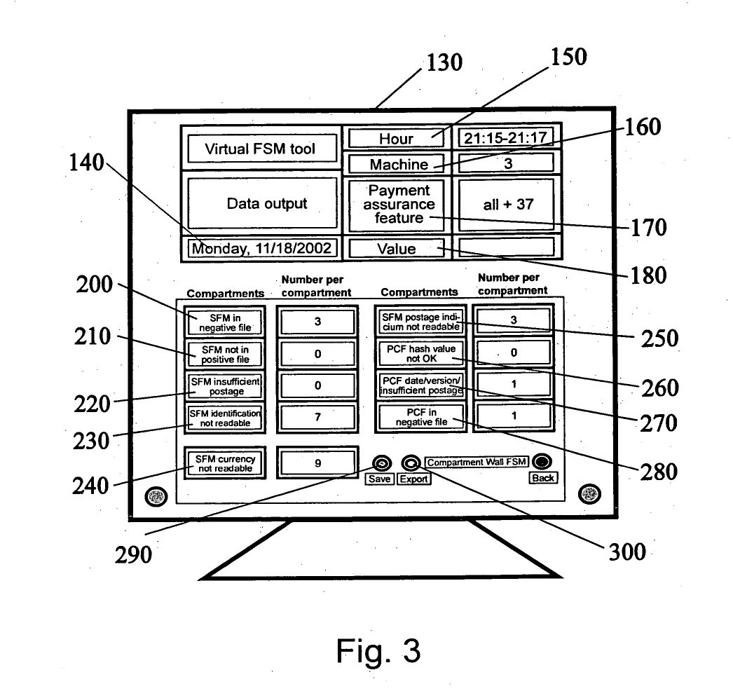

FIG. 3 shows another preferred embodiment of the invention. On the basis of the acquired graphic information, the authenticity of the SFM and PCF postage indicia is verified, so that the graphic information in this embodiment is sorted graphically—into virtual compartments. The results of the virtual checking 90 (FIG. 1) of the postage are classified under the employed sorting features and displayed on the display device 130. In the depiction shown by way of an example in FIG. 3, for instance, the following number of mailpieces could be sorted into the virtual compartments provided for them:

In the case of three mailpieces, the determined SFM identification is already in the negative file so that their graphic information is allocated to the virtual compartment “SFM in negative file” 200. None of the evaluated SFM identifications was previously in the positive file so that no graphic information is present in the virtual compartment “SFM in positive file” 210. Moreover, no SFM insufficient postage could be ascertained by the virtual checking of the postage, as a result of which the virtual compartment “SFM insufficient postage” 220 does not contain any graphic information. However, all in all, seven mailpieces could be found whose SFM identification was not readable, which leads to a set of 7 items of graphic information in the virtual compartment “SFM not readable” 230. Moreover, the SFM currency (“SFM currency not readable” 240) was not readable for nine mailpieces, and the SFM franking (“SFM franking not readable” 250) was not readable for three mailpieces.

Further results of the evaluation show that no mailpiece with an incorrect PCF hash value was found by the evaluation (no graphic information in the compartment “PCF hash value not OK” 260), and furthermore that one mailpiece was found that had an impermissible PCF date, an impermissible PCF version and/or PCF insufficient postage 270. The last evaluation result of this example shows that one mailpiece was already in the PCF negative file (“PCF in negative file” 280). The above-mentioned graphic display of the evaluation results is such that, by means of a graphic activation on the display device or by means of the input device, all of the graphic information complied in a given virtual compartment is listed.

In the case of the embodiment according to FIG. 3, the display device 130 is also provided with two additional operating units on the front faceplate. By actuating the operating unit 290, all of the evaluation results are stored. Actuating the operating unit 300 exports the data of all of the evaluation results to an external data medium that is located outside of the data network.

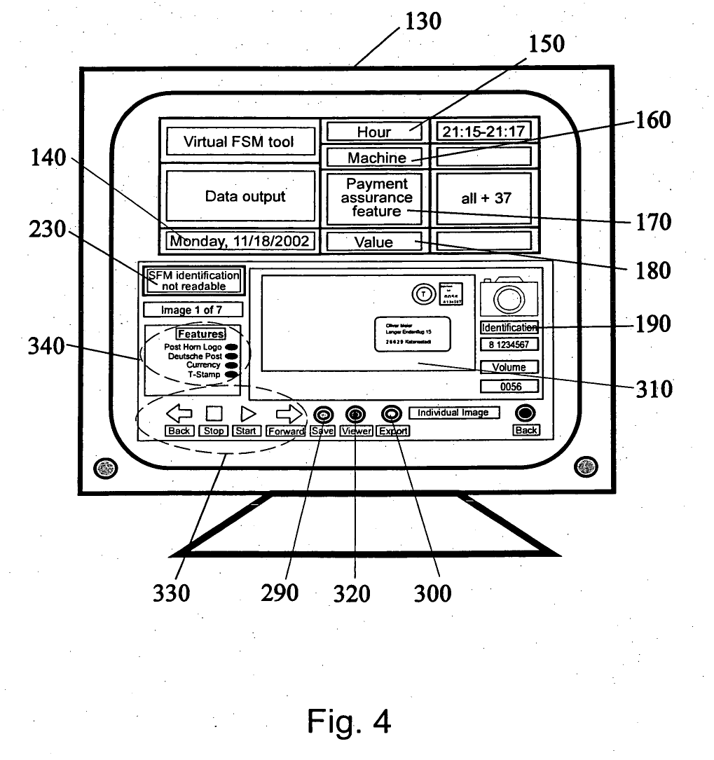

FIG. 4 shows another embodiment based on the display according to the invention of evaluation results as well as of details of the graphic information 310. The display of graphic information is activated by means of the operating unit 320 on the faceplate of the display device 130. Moreover, another operating unit 330 allows a targeted image processing of the graphic information. Here, either individual areas of the displayed graphic information or else graphic information of mailpieces that differ from each other can be selected.

### LIST OF REFERENCE NUMERALS

01 yes
02 no
10 input information
20 acquisition of the graphic information
30 storage device
40 checking for the presence of a reference code
50 automated checking of the postage
60 normal conveying sequence
70 checking for correct franking
80 printing of the reference code
90 virtual FS
100 physical sorting
110 database ZinS
120 sorting features
130 display device
140 indication of the date
150 indication of the starting and ending time
160 indication of the machine number
170 indication of the payment assurance sorting feature
180 indication of the ascertained insufficient postage value
190 indication of the ascertained SFM identification
200 number of compartments in the negative file for mailpieces with SFM postage
210 number of compartments in the positive file for mailpieces with SFM postage
220 number of compartments for mailpieces with insufficient postage with SFM postage
230 number of compartments for mailpieces whose SFM identification is not readable
240 number of compartments for mailpieces whose SFM currency is not readable
250 number of compartments for mailpieces whose SFM franking is not readable
260 number of compartments for mailpieces whose PCF hash value is not readable
270 number of compartments for mailpieces for which an impermissible PCF date, an impermissible PCF version and/or PCF insufficient postage was ascertained
280 number of compartments for mailpieces whose SFM identification is not readable
290 operation for purposes of storing the evaluation results of the virtual FS
300 operation for purposes of exporting data of the evaluation results of the virtual FS
310 depiction of the acquired graphic information
320 operation for purposes of activating the depiction of the acquired graphic information
330 operation for purposes of processing the graphic information
340 free surface for advertising imprints

1. A method for processing graphic information present on mailpieces, whereby the graphic information is acquired, evaluated and stored, and whereby the acquired graphic information is used for physically sorting mailpieces, the method comprising:
evaluating the graphic information to obtain a first result,
augmenting a database with additional sorting features based on the first result,
storing surface video data contained in the graphic information and/or storing a statistical evaluation,
ascertaining a second result of the evaluation,
sorting a first mailpiece on the basis of the second result,
triggering a physical sorting of a second mailpiece based on the graphical information of the first mailpiece,
and physically sorting the first mailpiece based on a reference code.

2. The method according to claim 1, comprising
determining if postage indicia are present on the mailpieces.

3. The method according to claim 1, wherein
evaluating the graphic information takes place via a data line at a different point in time and/or at a different place than the point in time and/or the place of the physical sorting of the first mailpiece based on the reference code.

4. The method according to claim 1, wherein
evaluating the graphic information comprises a statistically evaluating the graphic information.

5. The method according to claim 1, comprising
verifying the authenticity of sender franking by comparing the graphic information present on the mailpieces to the graphic information expected for a particular mailpiece, whereby expected graphic information corresponds to a determination that preceded the comparison, and registering a postage indicium as being forged if the graphic information present differs from the expected graphic information.

6. The method according to claim 1, comprising
verifying the authenticity of a digital postage indicium by deciphering the encoded digital information contained in the graphic information and comparing the encoded digital information to unencrypted graphic information present on the appertaining mailpiece to determine whether the encoded digital information matches the unencrypted graphic information and, if the encoded digital information does not match the unencrypted graphic information, registering the postage indicium as being forged.

7. The method according to claim 6, comprising
generating a first hash value from data contained in the graphic information in order to check whether the first hash value matches a second hash value contained in the encoded information and, if the first hash value does not match the second hash value, registering the postage indicium as being forged.

8. The method according to claim 7, comprising
forming the first hash value taking into account information about mailpiece data, taking into account a temporarily stored random number and taking into account a loading procedure identification number.

9. The method according to claim 1, comprising
evaluating the graphic information according to one or more sorting features.

10. The method according to claim 9, wherein
a time of day of a sorting event is a sorting feature of the evaluation.

11. The method according to claim 9, wherein
a date of a sorting event is a sorting feature.

12. The method according to claim 9, wherein
a starting time and/or an ending time of a sorting event is a sorting feature.

13. The method according to claim 9, wherein
a specification of production machines in a mail or freight distribution center is a sorting feature.

14. The method according to claim 9, wherein
a value of the insufficient postage determined by means of the evaluation is a sorting feature.

15. The method according to claim 9, wherein
a Sender Franking Machine (SFM) identification determined by means of the evaluation is a sorting feature.

16. The method according to claim 15, wherein
the SFM identification being readable is a sorting feature.

17. The method according to claim 15, comprising
checking whether the determined SFM identification is present in a negative file.

18. The method according to claim 15, comprising
checking whether the determined SFM identification is present in a positive file.

19. The method according to claim 15, comprising
checking whether the SFM has insufficient postage.

20. The method according to claim 15, comprising
checking whether the SFM currency is readable.

21. The method according to claim 15, comprising
checking whether SFM postage indicium is readable.

22. The method according to claim 9, comprising
checking a date of a Personal Computer Franking (“PCF date”) as a sorting feature.

23. The method according to claim 9, comprising
checking whether a Personal Computer Franking version (“PCF version”) is present as a sorting feature.

24. The method according to claim 9, comprising
checking whether Personal Computer Franking insufficient postage (“PCF insufficient postage”) is present as a sorting feature.

25. The method according to claim 9, comprising
checking whether a determined Personal Computer Franking is present in a negative file (“PCF in negative file”) as a sorting feature.

26. The method according to claim 1, comprising
storing data from automated checking of the postage.

27. The method according to claim 1, comprising
storing results of the evaluation of graphic information in a database.

28. A device for processing graphic information present on the surfaces of mailpieces comprising
an image processing unit, whereby the image processing unit has a device for acquiring, evaluating and storing the graphic information, and has at least one device for recognizing different types of postage of the mailpieces, whereby the image processing unit as well as the device for recognizing the types of postage are in a data network,
wherein the data network is connected to at least one device for performing a physical sorting of mailpieces, at least one device for generating a reference code, and at least one device for evaluating the graphic information, so that the at least one device for evaluating the graphic information of a first mailpiece ascertains a first result of the evaluation, whereby the data network is also connected to a database that is augmented by a sorting feature on the basis of the first result of the evaluation of the graphic information, for determining a second result of the evaluations and at least one device for performing the physical sorting of a second mailpiece is activated, whereby a second physical sorting of the first mailpiece is carried out on the basis of a reference code.

29. The device according to claim 28, wherein
the at least one device for evaluating the graphic information of the mailpieces is located inside and/or outside of a mail distribution center.

30. The device according to claim 28, wherein
the at least one device for evaluating the graphic information of the mailpieces has at least one input device and at least one display device so that evaluation results and surface video data of the mailpieces are displayed to a user and edited by the user employing the input device.

31. The device according to claim 30, wherein
the at least one display device comprises analog and/or digital video equipment.

32. The device according to claim 30, comprising
PC-based display devices that allow a filtering of the video data and a detailed depiction of specific segments of the video data.

33. The device according to claim 30, wherein
the at least one input device is selected from the group consisting of PC keyboards, numerical keypads, barcode scanners and a device for speech recognition.
